(19) United States
(12) Patent Application Publication
(10) Pub. No.: US 2026/0310393 A1
(43) Pub. Date: Oct. 8, 2026

(54) PRINTING SYSTEM, STORAGE MEDIUM STORING PRINT PROGRAM, AND CONTROL METHOD FOR INFORMATION PROCESSING APPARATUS

(71) Applicant: CANON KABUSHIKI KAISHA, Tokyo (JP)

(72) Inventor: Hiroshi Kikuchi, Kanagawa (JP)

(21) Appl. No.: 19/564,708

(22) Filed: Mar. 12, 2026

(30) Foreign Application Priority Data
Apr. 7, 2025 (JP) 2025-063060

(51) Int. Cl. G06F 3/12

(52) U.S. Cl. CPC G06F 3/1252; G06F 3/1208; G06F 3/1253

(57) ABSTRACT

A printing system capable of specifying a discharging order of pages. The printing system includes an information processing apparatus and a printing device which are communicably connected. The information processing apparatus includes a first generation unit that generates print data of multiple pages, a second generation unit that generates, based on the print data, changed print data so as to be discharged in a reverse order by the printing device, an assignment unit that assigns information regarding the reverse order to the changed print data, and a transmission unit that transmits the changed print data with the assigned information to the printing device. The printing device includes a receiving unit that receives the changed print data to which the information is assigned, and a printing unit that prints the changed print data in an as-is order in a case where the changed print data is received by the receiving unit.

### BACKGROUND

### Field of the Technology

The aspect of the embodiments relates to a printing system, a storage medium storing a print program, and a control method for an information processing apparatus.

### Description of the Related Art

As printing devices, a face-down machine that discharges a printed surface downward during single-sided printing and a face-up machine that discharges a printed surface upward during single-sided printing are known. When print data for multiple pages is printed by the face-down machine, the printed sheets are arranged in an ascending order of a page number of the printed surface of each printing sheet. For example, when printed matter is constituted by ten pages, a first page is arranged at a top of the printed matter. On the other hand, when print data for multiple pages is printed by the face-up machine, the printed sheets are arranged in a descending order of a page number of the printed surface of each printing sheet. For example, printed matter is constituted by ten pages, a tenth page is arranged at the top of the printed matter. Japanese Patent Laid-Open Publication No. 2007-307849 discloses a configuration in which, regardless of whether a printing device is a face-down machine or a face-up machine, printed sheets are output so as to be arranged in order from a top page, that is, a page order in the printed matter is in a correct state.

However, the configuration described in the above publication has a problem that a user cannot specify a page order of discharging pages even when the user wants to specify the page order.

### SUMMARY

The present disclosure provides a mechanism capable of specifying a page order of discharging pages.

Accordingly, an aspect of the embodiments provides a printing system including an information processing apparatus and a printing device communicably connected to the information processing apparatus. The information processing apparatus includes a first generation unit configured to generate print data of multiple pages, a second generation unit configured to generate, based on the print data, changed print data in which an order of the multiple pages is changed so that the multiple pages are discharged in a reverse order by the printing device, an assignment unit configured to assign information regarding the reverse order to the changed print data generated by the second generation unit, and a transmission unit configured to transmits the changed print data to which the information is assigned by the assignment unit to the printing device. The printing device includes a receiving unit configured to receive the changed print data to which the information is assigned by the assignment unit, the changed print data being transmitted from the transmission unit, and a printing unit configured to print the changed print data in an as-is order in a case where the changed print data to which the information is assigned by the assignment unit is received by the receiving unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a network configuration of a printing system.

FIG. 2 is a block diagram showing a hardware configuration of a first computer.

FIG. 3 is a block diagram showing a hardware configuration of a first printer.

FIG. 4 is a block diagram showing a software configuration of the first computer.

FIG. 5 is a diagram showing a process executed between software components of the first computer during printing.

FIG. 6A is a schematic diagram showing a print job from a second computer, and FIG. 6B is a schematic diagram showing an output result of a second printer that is a face-down machine.

FIG. 7 is a diagram showing an example of a setting screen displayed on a display unit of the first printer.

FIG. 8 is a diagram showing an example of a print setting screen displayed on a display unit of the first computer.

FIG. 9 is a diagram showing an example of an ability information screen displayed on the display unit of the first computer.

FIG. 10 is a flowchart showing a process executed by the first computer.

FIG. 11 is a flowchart showing a process executed by the first printer.

FIG. 12 is a table showing relationships between print settings in the first computer, print settings in the first printer, and output results.

### DESCRIPTION OF THE EMBODIMENTS

Hereinafter, embodiments of the present disclosure will be described in detail with reference to the drawings. However, configurations described in the following embodiments are merely examples, and a scope of the present disclosure is not limited by the configurations described in the embodiments. For example, each part constituting the present disclosure can be replaced with an arbitrary configuration capable of exerting a similar function. In addition, an arbitrary component may be added.

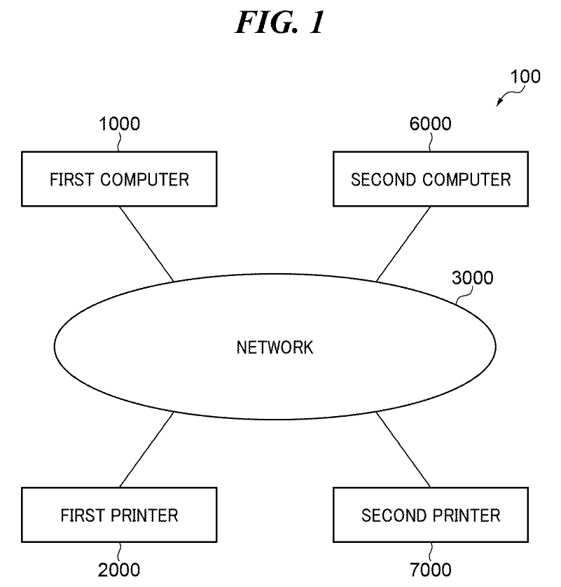

FIG. 1 is a block diagram showing a network configuration of a printing system. As shown in FIG. 1, the printing system 100 includes a first computer (an information processing apparatus) 1000, a second computer (an information processing apparatus) 6000, a first printer (a printing device) 2000, and a second printer (a printing device) 7000. These devices included in the printing system 100 are communicably connected with each other via a network 3000. Accordingly, the first computer 1000 can issue a print job to the first printer 2000 or the second printer 7000 via the network 3000. Then, the first printer 2000 or the second printer 7000 can receive the print job from the first computer 1000 and perform printing.

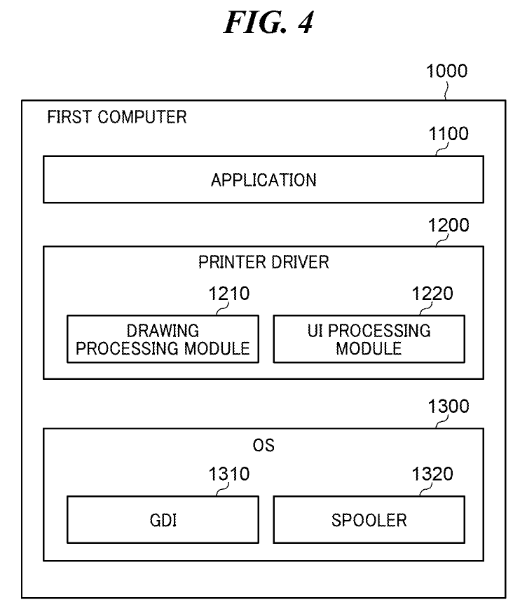

The first computer 1000 includes a printer driver 1200 (see FIG. 4). The second computer 6000 includes a standard printer driver included in an OS 1300 instead of the printer driver 1200. Note that the second computer 6000 may include a system or the like capable of generating print data (PDL: page description language) that the first printer 2000 and the second printer 7000 can interpret, instead of the printer driver 1200. The first printer 2000 is a face-up machine that discharges a printed surface upward during single-sided printing. The second printer 7000 is a face-down machine that discharges a printed surface downward during single-sided printing.

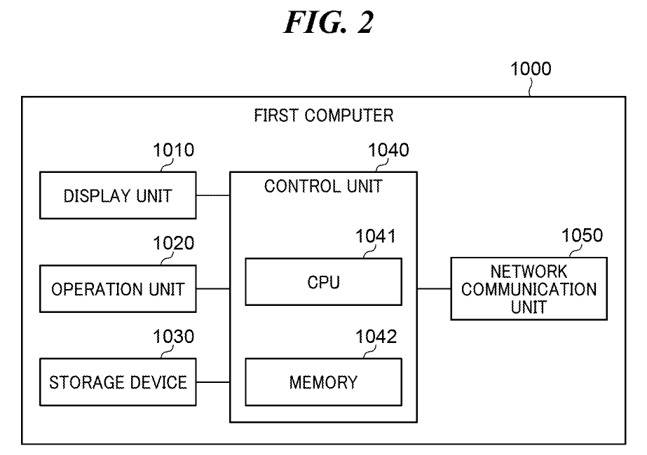

FIG. 2 is a block diagram showing a hardware configuration of the first computer. As shown in FIG. 2, the first computer 1000 includes a display unit 1010, an operation unit 1020, a storage device (storage medium) 1030, a control unit 1040, and a network communication unit 1050. The control unit 1040 includes a CPU 1041 and a memory 1042, and controls the entire first computer 1000. The display unit 1010 is configured by an output device such as a display, and can display various types of information and the like. The operation unit 1020 is configured by, for example, input devices such as a mouse, a keyboard, and a touch panel, and allows operations to input various types of information.

The storage device 1030 is configured by a storage medium such as a hard disk or an SSD, and, for example, stores various types of software required when the first computer 1000 operates. The software includes, for example, a program or the like for causing the CPU 1041 (computer) to execute each process (control method) described later. The network communication unit 1050 is connected to the network 3000. Accordingly, the first computer 1000 can communicate with the first printer 2000 and the second printer 7000.

Note that in the present embodiment, a software process in the first computer 1000 is achieved by the CPU 1041 executing the software stored in the storage device 1030 after loading the software into the memory 1042 of the control unit 1040. Also, in the present embodiment, a hardware configuration of the second computer 6000 is similar to the hardware configuration of the first computer 1000.

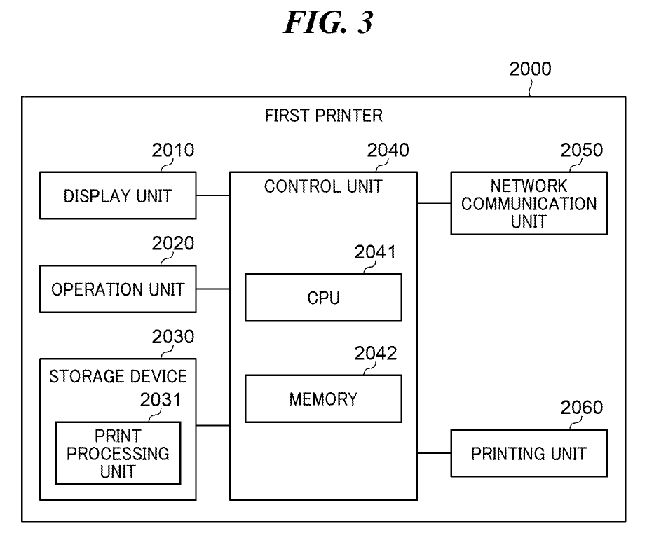

FIG. 3 is a block diagram showing a hardware configuration of the first printer. As shown in FIG. 3, the first printer 2000 includes a display unit 2010, an operation unit 2020, a storage device 2030, a control unit 2040, a network communication unit 2050, and a printing unit 2060. The control unit 2040 includes a CPU 2041 and a memory 2042, and controls the entire first printer 2000. The display unit 2010 is configured by an output device such as a liquid crystal panel, and can display various types of information. The operation unit 2020 is configured by, for example, an input device such as hard buttons and a touch panel, and allows operations to input various types of information.

The storage device 2030 is configured by a storage medium such as a hard disk or an SSD, and stores various types of software required when the first printer 2000 operates. Also, the storage device 2030 stores a print processing unit 2031 that performs a printing process. The network communication unit 2050 is connected to the network 3000. The printing unit 2060 performs the printing process on a sheet being conveyed using toner or ink.

Note that in the present embodiment, a software process in the first printer 2000 is achieved by the CPU 2041 executing the software stored in the storage device 2030 after loading the software into the memory 2042. Also, in the present embodiment, a hardware configuration of the second printer 7000 is similar to the hardware configuration of the first printer 2000.

FIG. 4 is a block diagram showing a software configuration of the first computer. As shown in FIG. 4, the storage device 1030 of the first computer 1000 stores an application 1100, the printer driver 1200, and the OS 1300. The application 1100 is software such as, for example, document creation software or spreadsheet software. A user using the first computer 1000 can cause, for example, the second printer 7000 to print a document, a table, or the like being displayed on the display unit 1010 of the first computer 1000 by the application 1100.

The printer driver 1200 displays a UI for a print setting that can be achieved by using, for example, the second printer 7000, or generates print data (PDL) that the second printer 7000 can interpret during printing. The printer driver 1200 includes a drawing processing module 1210 mainly used when the PDL is generated, and a UI processing module 1220 mainly used when a print setting is displayed or changed. An OS 1300 is software for controlling a basic operation of the first computer 1000. Each of an application 1100 and the printer driver 1200 becomes usable by being installed in the OS 1300, and is managed by the OS 1300. The OS 1300 includes a GDI 1310 and a spooler (a transmission unit) 1320. The GDI 1310 provides an interface regarding drawing such as display on a display or printing. The spooler 1320 transmits print data to, for example, the second printer 7000.

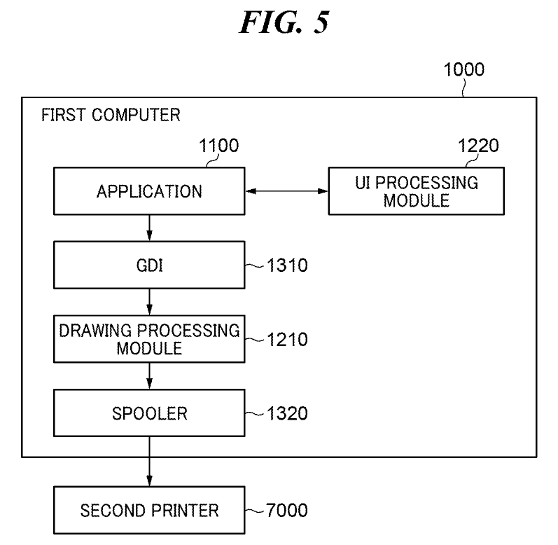

FIG. 5 is a diagram showing a process executed between the software components of the first computer during printing. As shown in FIG. 5, the application 1100 calls the UI processing module 1220 of the printer driver 1200 before executing the printing process. Accordingly, the user can perform an arbitrary print setting on a user interface (hereinafter referred to as a “UI”) displayed by the UI processing module 1220.

Thereafter, the application 1100 issues a drawing instruction to the GDI 1310 together with the print setting obtained via the UI processing module 1220. The GDI 1310 converts the print setting and the drawing instruction into an instruction that the printer driver 1200 can interpret, and calls the drawing processing module 1210. The drawing processing module 1210 converts the print setting and the drawing instruction obtained via the GDI 1310 into print data (PDL) that the second printer 7000 can interpret, and transmits the print data to the spooler 1320. The spooler 1320 transmits the PDL to the second printer 7000. The second printer 7000 converts the PDL into image data and prints the image data on a sheet using the printing unit 2060.

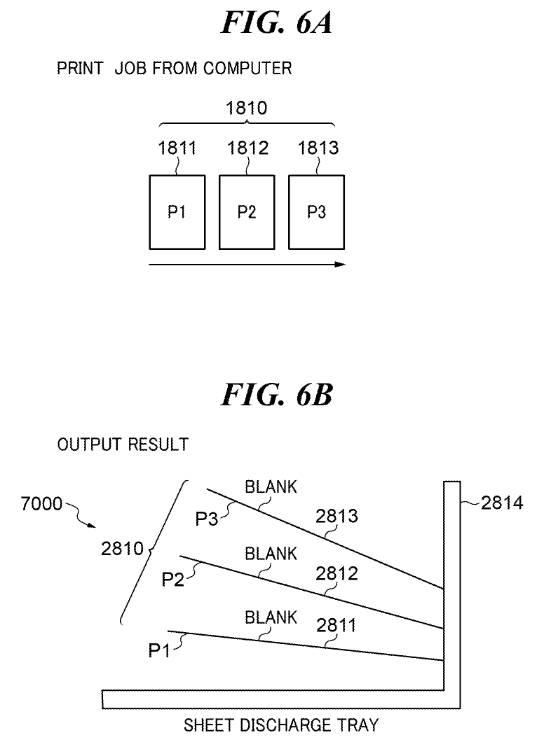

FIG. 6A is a schematic diagram showing an example of a print job from the second computer. FIG. 6B is a schematic diagram showing an example of an output result of the second printer that is a face-down machine. As shown in FIG. 6A, a print job 1810 includes print data 1811 for a first page, print data 1812 for a second page, and print data 1813 for a third page. Note that in the present embodiment, the print job 1810 includes the print data for three pages, but is not limited to this, and for example, may include the print data for two pages or the print data for four or more pages.

As shown in FIG. 6B, the second printer 7000 receives the print job 1810 and discharges printed matter 2810 in a face-down manner to a discharge tray 2814 that is a part of the printing unit 2060. The printed matter 2810 include printed sheets 2811, 2812, and 2813. For the sheet 2811, a printed surface on which the print data 1811 is printed faces downward, and a blank surface faces upward. On the sheet 2811, the sheet 2812 is overlapped. For the sheet 2812, a printed surface on which the print data 1812 is printed faces downward, and a blank surface faces upward. On the sheet 2812, the sheet 2813 is overlapped. For the sheet 2813, a printed surface on which the print data 1813 is printed faces downward, and a blank surface faces upward. In the printed matter 2810 including the sheets 2811, 2812, and 2813 discharged in the face-down manner in this way, each printed surface faces a front side, and the sheets are arranged in an ascending order of a page number.

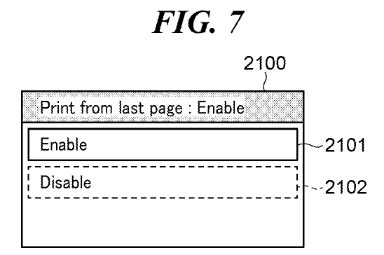

FIG. 7 is a diagram showing an example of a setting screen displayed on a display unit of a first printer. A setting screen 2100 shown in FIG. 7 is a screen on which an operation for selecting whether to change an order of multiple pages so that the multiple pages included in the print data are discharged in a reverse order when the print data is printed by the first printer 2000 is performed. That is, the setting screen 2100 is a screen on which an operation for selecting whether to print multiple pages included in print data in an ascending order of a page number (from a first page) or in a descending order of a page number (from a last page) is performed.

The setting screen 2100 includes a first button 2101 and a second button 2102. When the first button 2101 is selected, “printing from last page” is set in principle, and the print processing unit 2031 of the first printer 2000 is controlled so as to print from the last page. When the second button 2102 is selected, “printing from last page” is not set in principle, that is, “printing from first page” is set, and the print processing unit 2031 of the first printer 2000 is controlled so as to print from the first page.

As described later, even when the first button 2101 is selected, “printing from last page” might not be set, and even when the second button 2102 is selected, “printing from first page” might not be set. Hereinafter, the setting of “printing from last page” may be referred to as “reverse order printing (reverse discharge)”. On the other hand, the setting of “printing from first page” may be referred to as “forward order printing (forward discharge)”.

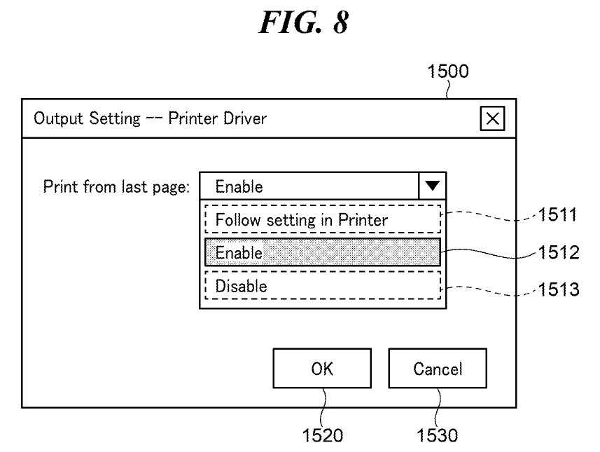

FIG. 8 is a diagram showing an example of a print setting screen displayed on the display unit of the first computer. A print setting screen 1500 shown in FIG. 8 is a reception screen that accepts whether to print in the reverse order when print data is printed by the first printer 2000, and is displayed by the printer driver 1200. In this way, in the present embodiment, the printer driver 1200 also functions as a display control unit that displays the print setting screen 1500.

The print setting screen 1500 includes a first button 1511, a second button 1512, a third button 1513, an OK button 1520, and a cancel button 1530. When the second button 1512 is selected, “printing from last page” is set, and the print processing unit 2031 of the first printer 2000 is forcibly controlled so that the reverse order printing is set, regardless of selection of the first button 2101 or the second button 2102 on the setting screen 2100. When the third button 1513 is selected, “printing from first page” is set, and the print processing unit 2031 of the first printer 2000 is forcibly controlled so that the forward order printing is set, regardless of selection of the first button 2101 or the second button 2102 on the setting screen 2100. In this way, an order selection of whether to print in the reverse order is accepted by selecting the second button 1512 or the third button 1513.

On the other hand, when neither of the second button 1512 nor the third button 1513 is selected, the first button 1511 can be selected. The first button 1511 is a choice selected when a discharge order of the first printer 2000 follows an order set in advance in the first printer 2000. For example, when the first button 1511 is selected and the first button 2101 is selected in advance on the setting screen 2100, the print processing unit 2031 of the first printer 2000 is controlled so that the reverse order printing is set.

When the first button 1511 is selected and the second button 2102 is selected on the setting screen 2100, the print processing unit 2031 of the first printer 2000 is controlled so that the forward order printing is set. In this way, by selecting the first button 1511, the selection between the forward order printing and the reverse order printing in the first computer 1000 can be omitted. Then, when the OK button 1520 is pressed in a state where any one of the first button 1511 to the third button 1513 is selected, the instruction content by the selected button is determined, and the print setting screen 1500 is closed.

On the other hand, when the cancel button 1530 is pressed in the state where any one of the first button 1511 to the third button 1513 is selected, the instruction content by the selected button is canceled, and the print setting screen 1500 is closed. A user can specify the discharge order of printed sheets in the first printer 2000 with using the print setting screen 1500 configured as described above.

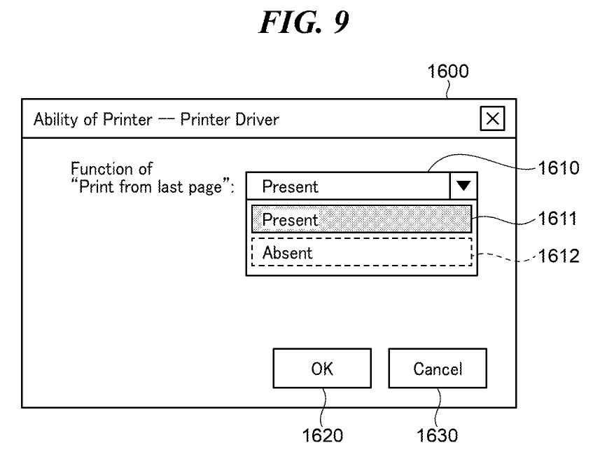

FIG. 9 is a diagram showing an example of an ability information screen displayed on the display unit of a first computer. An ability information screen 1600 shown in FIG. 9 is a screen that displays ability information about whether the first printer 2000 supports the reverse order printing. The ability information is obtained from the first printer 2000 by the printer driver 1200. The ability information screen 1600 includes a display field 1610, first information 1611, second information 1612, an OK button 1620, and a cancel button 1630. The first information 1611 shows that the reverse order printing is possible. The second information 1612 shows that the reverse order printing is impossible.

In a state shown in FIG. 9, as an example, the first information 1611 is highlighted, and information similar to the first information 1611 is displayed in the display field 1610. Then, in this case, the print setting screen 1500 (see FIG. 8) can be displayed. In contrast, when information similar to the second information 1612 is displayed in the display field 1610, the print setting screen 1500 is not displayed. With such an ability information screen 1600, presence or absence of a reverse order printing function in the first printer 2000 is displayed.

Depending on an environment of the network 3000, it might become difficult to obtain ability information from the first printer 2000. In this case, the first information 1611 or the second information 1612 can be manually changed. Also, by pressing the OK button 1620, the information displayed in the display field 1610 is stored in the storage device 1030, and the ability information screen 1600 is closed. Also, by pressing the cancel button 1630, storage of the information displayed in the display field 1610 is omitted, and the ability information screen 1600 is closed.

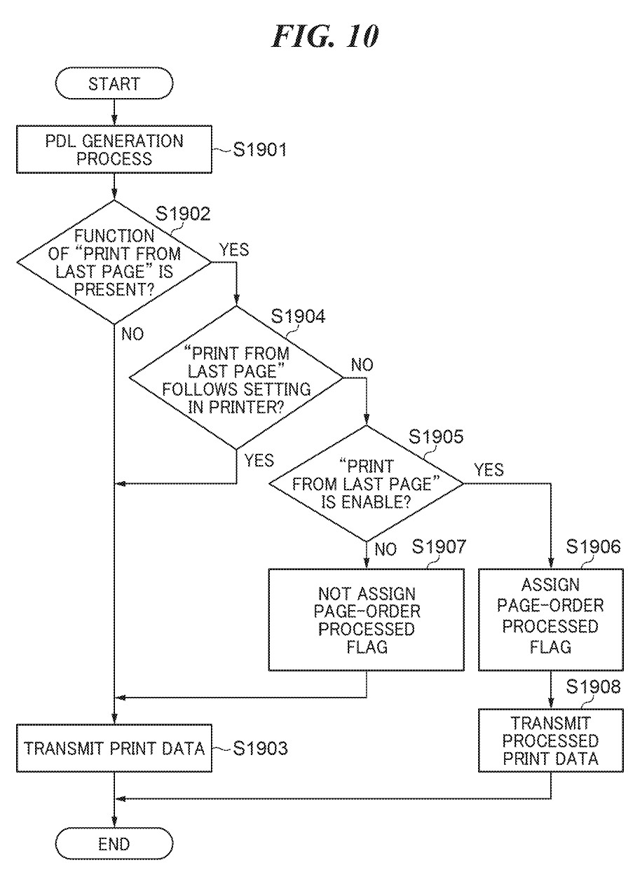

FIG. 10 is a flowchart showing a process executed by the first computer. A program based on the flowchart shown in FIG. 10 is stored in advance in the storage device 1030 of the first computer 1000. Also, the program is loaded into the memory 1042 and is executed by the CPU 1041. As shown in FIG. 10, in a step S1901, the drawing processing module 1210 executes a PDL generation process to generate print data (PDL) of multiple pages from data from the application 1100 according to an instruction from the GDI 1310 (a first generation step). In this way, in the present embodiment, the drawing processing module 1210 functions as a first generation unit that generates print data of multiple pages.

In a step S1902, the drawing processing module 1210 obtains ability information from the first printer 2000 and determines whether a reverse order printing capability (the function of “print from last page”) is included in the ability information, that is, presence or absence of the reverse order printing capability in the ability information. In this way, in the present embodiment, the drawing processing module 1210 functions as an obtaining unit that obtains ability information from the first printer 2000. Further, the drawing processing module 1210 functions as a determination unit that determines whether ability information including the reverse order printing capability has been obtained. Also, the determination in the step S1902 is performed based on display contents in the ability information screen 1600. When it is determined that the reverse order printing capability is present as a result of the determination in the step S1902, the process proceeds to a step S1904. On the other hand, when it is determined that the reverse order printing capability is absent as a result of the determination in the step S1902, the process proceeds to a step S1903.

In the step S1903, the spooler 1320 transmits the print data generated in the step S1901 to the first printer 2000.

In the step S1904, the drawing processing module 1210 determines whether the first button 1511 (follow setting in printer) has been selected from among the first button 1511 to the third button 1513 on the print setting screen 1500. As described above, the first button 1511 is selected when the discharge order in the first printer 2000 follows an order set in advance in the first printer 2000. When it is determined that the first button 1511 has been selected as a result of the determination in the step S1904, the process proceeds to the step S1903. On the other hand, when it is determined that the first button 1511 has not been selected as a result of the determination in the step S1904, the process proceeds to a step S1905.

In the step S1905, the drawing processing module 1210 determines whether the second button 1512 has been selected from the second button 1512 and the third button 1513 on the print setting screen 1500. As described above, the second button 1512 is selected when the print processing unit 2031 of the first printer 2000 is controlled so that the reverse order printing is possible. When it is determined that the second button 1512 has been selected as a result of the determination in the step S1905, the process proceeds to a step S1906. On the other hand, when it is determined that the second button 1512 has not been selected, that is, the third button 1513 has been selected as a result of the determination in the step S1905, the process proceeds to a step S1907. As described above, the third button 1513 is selected when the print processing unit 2031 of the first printer 2000 is controlled so that the forward order printing is possible.

In the step S1906, the drawing processing module 1210 generates print data (hereinafter referred to as “changed print data”) in which an order of multiple pages is changed so that the multiple pages of the print data generated in the step S1901 are discharged in a reverse order in the first printer 2000 (a second generation step). In this way, in the present embodiment, the drawing processing module 1210 functions as a second generation unit that generates the changed print data. Also, the drawing processing module 1210 assigns a page-order processed flag (reverse order printing information), which shows information regarding reverse order printing, to the changed print data (an assignment step). In this way, in the present embodiment, the drawing processing module 1210 functions as an assignment unit that assigns the page-order processed flag. The page-order processed flag shows a state where an order of multiple pages included in the print data is changed so that the multiple pages are discharged in the reverse order, that is, in a descending order of a page number in the first printer 2000. After execution of the step S1906, the process proceeds to a step S1908.

In the step S1907, the drawing processing module 1210 omits generation of changed print data and assignment of the page-order processed flag, and the process proceeds to the step S1903.

In the step S1908, the spooler 1320 transmits the changed print data to which the page-order processed flag has been assigned in the step S1906 to the first printer 2000.

As described above, the first computer 1000 can designate the discharge order of the sheets printed by the first printer 2000.

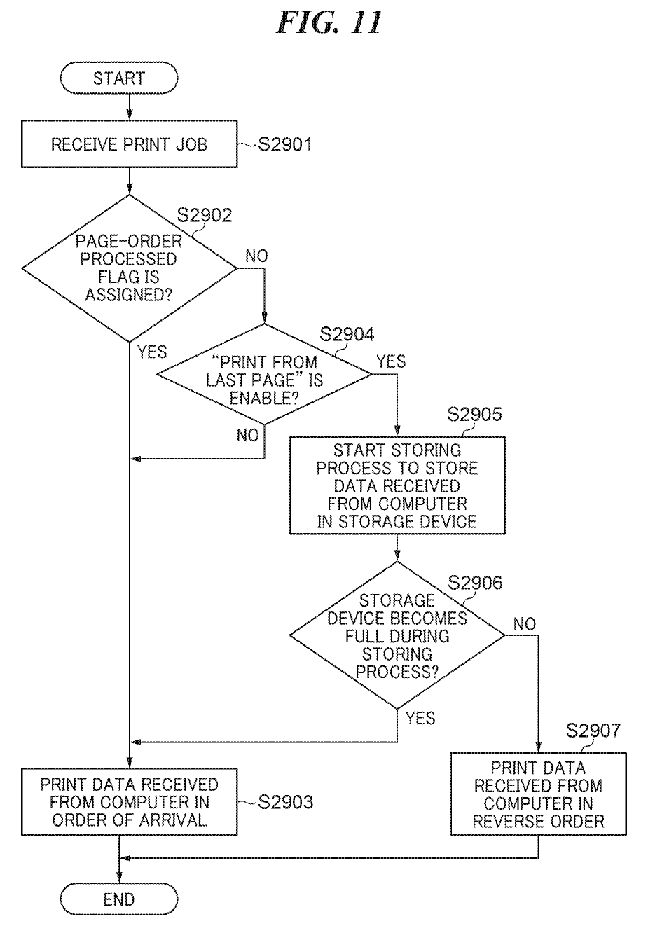

FIG. 11 is a flowchart showing a process executed by the first printer. A program based on the flowchart shown in FIG. 11 is stored in advance in the storage device 2030 of the first printer 2000. Also, the program is loaded into the memory 2042 and is executed by the CPU 2041. As shown in FIG. 11, in a step S2901, the print processing unit 2031 receives a print job from the first computer 1000 via the network 3000. The print job includes the print data transmitted in the step S1903 or the changed print data transmitted in the step S1908. In this way, in the present embodiment, the print processing unit 2031 functions as a receiving unit that receives a print job from the first computer 1000.

In a step S2902, the print processing unit 2031 determines whether the page-order processed flag is assigned to the print job received in the step S2901, that is, presence or absence of the page-order processed flag in the print job. When it is determined that the page-order processed flag is present as a result of the determination in the step S2902, the process proceeds to a step S2903. On the other hand, when it is determined that the page-order processed flag is absent as a result of the determination in the step S2902, the process proceeds to a step S2904.

In the step S2903, the print processing unit 2031 controls the printing unit 2060 to print the changed print data included in the print job received in the step S2901 in the as-is order. Accordingly, the first printer 2000 is able to omit rearrangement of the page order.

In the step S2904, the print processing unit 2031 determines whether the first button 2101 has been selected from among the first button 2101 and the second button 2102 on the setting screen 2100. As described above, the first button 2101 is selected when the print processing unit 2031 of the first printer 2000 is controlled so that the reverse order printing is possible. When it is determined that the first button 2101 has been selected as a result of the determination in the step S2904, the process proceeds to a step S2905.

On the other hand, when it is determined that the first button 2101 has not been selected, that is, the second button 2102 has been selected as a result of the determination in the step S2904, the process proceeds to the step S2903. As described above, the second button 2102 is selected when the print processing unit 2031 of the first printer 2000 is controlled so that the forward order printing is possible. Note that in the step S2903 in this case, the print processing unit 2031 controls the printing unit 2060 to print the print data included in the print job received in the step S2901 in the as-is order.

In the step S2905, the print processing unit 2031 starts a storing process to store the print data included in the print job received in the step S2901 into the storage device 2030.

In a step S2906, the print processing unit 2031 determines whether all the print data from a first page to a last page cannot be stored in the storage device 2030 by execution of the storage process started in the step S2905, that is, presence or absence of a memory overflow. When it is determined that a memory overflow is present as a result of the determination in the step S2906, the process proceeds to the step S2903. Note that in the step S2903 in this case, the print processing unit 2031 controls the printing unit 2060 and prints the print data included in the print job received in the step S2901 as it is. On the other hand, when it is determined that a memory overflow is absent as a result of the determination in the step S2906, the process proceeds to a step S2907.

In the step S2907, the print processing unit 2031 controls the printing unit 2060 to print the print data included in the print job received in the step S2901 with the reverse order printing.

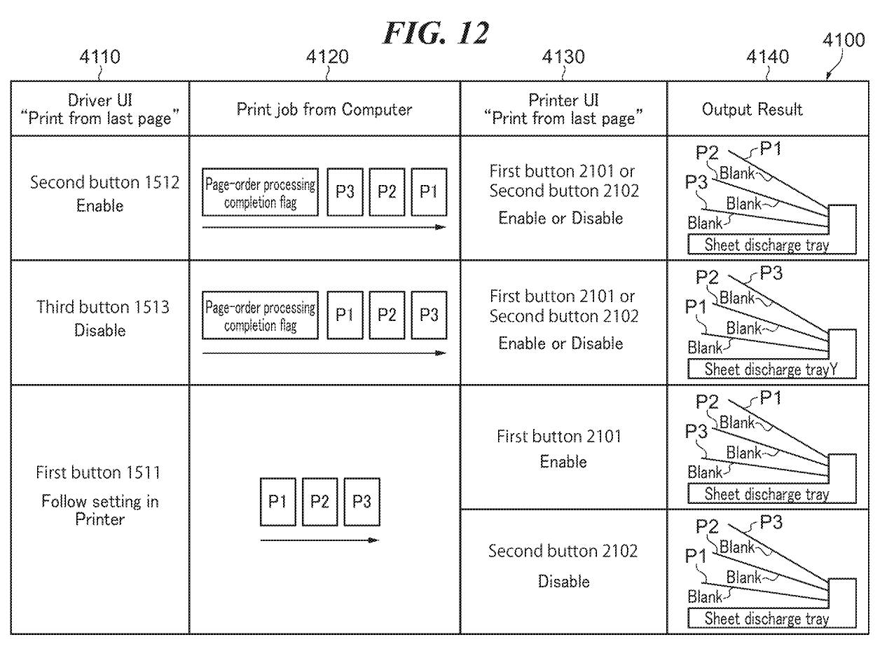

FIG. 12 is a table showing relationships between the print settings in the first computer, the print settings in the first printer, and the output results. The table 4100 shown in FIG. 12 includes columns 4110, 4120, 4130, and 4140. The column 4110 shows the choices of the first button 1511 to the third button 1513 on the print setting screen 1500. The column 4120 shows the states (schematic diagrams) of data included in print jobs corresponding to the choices in the column 4110, respectively. The column 4130 shows the choices of the first button 2101 and the second button 2102 on the setting screen 2100.

The column 4140 shows the output results (discharge results) in the first printer 2000 when the first button 1511 to the third button 1513 are selected. For example, when the second button 1512 is selected, the reverse order printing is performed regardless of selection of the first button 2101 or the second button 2102 on the setting screen 2100. Also, when the third button 1513 is selected, the forward order printing is performed regardless of selection of the first button 2101 or the second button 2102 on the setting screen 2100. Also, when the first button 1511 is selected and the first button 2101 is selected in advance on the setting screen 2100, the reverse order printing is performed. Also, when the first button 1511 is selected and the second button 2102 is selected on the setting screen 2100, the forward order printing is performed.

In the above embodiment, the present disclosure is applied to the case where a printing instruction is issued from the first computer 1000 to the first printer 2000, but the present disclosure is similarly applicable to a case where a printing instruction is issued from the first computer 1000 to the second printer 7000.

According to the present disclosure, a page order of the discharging pages can be specified.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063060, filed Apr. 7, 2025 which is hereby incorporated by reference herein in its entirety.

What is claimed is:

1. A printing system comprising:
an information processing apparatus comprising:
a first generation unit configured to generate print data of multiple pages;
a second generation unit configured to generate, based on the print data, changed print data in which an order of the multiple pages is changed so that the multiple pages are discharged in a reverse order by a printing device communicably connected to the information processing apparatus;
an assignment unit configured to assign information regarding the reverse order to the changed print data generated by the second generation unit; and
a transmission unit configured to transmits the changed print data to which the information is assigned by the assignment unit to the printing device; and
the printing device comprising:
a receiving unit configured to receive the changed print data to which the information is assigned by the assignment unit, the changed print data being transmitted from the transmission unit; and
a printing unit configured to print the changed print data in an as-is order in a case where the changed print data to which the information is assigned by the assignment unit is received by the receiving unit.

2. The printing system according to claim 1, wherein the transmission unit can transmit the print data generated by the first generation unit,
the receiving unit can receive the print data generated by the first generation unit and transmitted from the transmission unit, and
the printing unit prints the print data generated by the first generation unit in the reverse order when the print data is received by the receiving unit.

3. The printing system according to claim 1, wherein the information processing apparatus includes a display control unit configured to display a reception screen that accepts an order selection of whether to print in the reverse order,
the second generation unit generates the changed print data and the assignment unit assigns the information to the changed print data in a case where the order selection to print in the reverse order is selected on the reception screen, and
the second generation unit omits to generate the changed print data and the assignment unit omit to assign the information to the changed print data in a case where the order selection to print in the reverse order is not selected on the reception screen.

4. The printing system according to claim 3, wherein the reception screen includes a choice selected in a case where a discharge order in the printing device follows an order set in advance in the printing device, and
the choice can be selected in a state where the order selection is not accepted.

5. The printing system according to claim 3, wherein the information processing apparatus includes an obtaining unit configured to obtain ability information including reverse order printing capability from the printing device, and
the display control unit displays the reception screen based on the ability information obtained by the obtaining unit.

6. The printing system according to claim 5, wherein the information processing apparatus includes a determination unit configured to determine whether the ability information has been obtained by the obtaining unit, and
the display control unit displays the reception screen in a case where the determination unit has determined that the ability information has been obtained by the obtaining unit, and does not display the reception screen when in a case where the determination unit has determined that the ability information has not been obtained by the obtaining unit.

7. A non-transitory computer-readable storage medium storing a printing program causing a computer to execute a printing method comprising:
a first generation step of generating print data of multiple pages;
a second generation step of generating, based on the print data, changed print data in which an order of the multiple pages is changed so that the multiple pages are discharged in a reverse order by a printing device;
an assignment step of assigning information regarding the reverse order to the changed print data generated in the second generation step; and
a transmission step of transmitting the changed print data to which the information is assigned in the setting step to the printing device.

8. A control method for an information processing apparatus communicably connected to a printing device, the method comprising:
a first generation step of generating print data of multiple pages;
a second generation step of generating, based on the print data, changed print data in which an order of the multiple pages is changed so that the multiple pages are discharged in a reverse order by the printing device;
an assignment step of assigning information regarding the reverse order to the changed print data generated in the second generation step; and
a transmission step of transmitting the changed print data to which the information is assigned in the assignment step to the printing device.
